(19) United States
(12) Patent Application Publication
(10) Pub. No.: US 2026/0179006 A1
(43) Pub. Date: Jun. 25, 2026

(54) Cloud Service Provider (CSP) Event Capture and Processing System

(71) Applicant: Zscaler, Inc., San Jose, CA (US)

(72) Inventors: Anand Subbaraman, Pune (IN); Ragavendra Annakula, Hyderabad (IN); Kushagra Kasbi, Pune (IN); Vaibhav Avasarla Krishna, Hyderabad (IN); Divya B, Bengaluru (IN); Durgesh Atal, Pune (IN); Aadarsh Uday Kondekar, Pune (IN); Varuni Agarwal, Surat (IN)

(73) Assignee: Zscaler, Inc., San Jose, CA (US)

(21) Appl. No.: 19/068,234

(22) Filed: Mar. 3, 2025

(30) Foreign Application Priority Data
Dec. 19, 2024 (IN) 202441100819

(51) Int. Cl. G06Q 10/0631

(52) U.S. Cl. CPC G06Q 10/06312

(57) ABSTRACT

Systems and methods for a Cloud Service Provider (CSP) event capture and processing system include retrieving a change feed from one or more Cloud Service Providers (CSPs) associated with a customer of the cloud-based system; analyzing the change feeds to identify modifications of one or more resources within network environments associated with the customer, wherein the network environments are provided by the one or more CSPs; updating a data store of the customer with any new or modified resources based on the analyzing; and providing a customer-specific dashboard including analytics for all CSPs associated with the customer of the cloud-based system.

### FIELD OF THE DISCLOSURE

The present disclosure generally relates to network and cloud security. More particularly, the present disclosure relates to systems and methods for a CSP event capture and processing system.

### BACKGROUND OF THE DISCLOSURE

Detecting changes within a Cloud Service Provider (CSP) environment traditionally involves a variety of methods, including monitoring configurations, auditing access logs, and using automated security tools. Configuration monitoring tools can track any alterations in cloud resources, such as updates to security groups, changes in storage permissions, or the deployment of new virtual machines. Access logs are crucial for tracking user activity and identifying unauthorized access or unusual behavior, while automated security platforms provide real-time alerts and insights into potential threats or misconfigurations. However, challenges in this area include the sheer volume of changes in dynamic cloud environments, which can make it difficult to distinguish between legitimate updates and suspicious activities. Additionally, cloud environments often span multiple accounts, each account having multiple regions, each region having multiple services, complicating efforts to gain comprehensive visibility. The complexity of managing and correlating data from different sources and platforms can also lead to delays in detecting and responding to critical issues, increasing the risk of security breaches.

### BRIEF SUMMARY OF THE DISCLOSURE

The present disclosure relates to systems and methods for a CSP event capture and processing system. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include retrieving a change feed from one or more Cloud Service Providers (CSPs) associated with a customer of the cloud-based system; analyzing the change feeds to identify modifications of one or more resources within network environments associated with the customer, wherein the network environments are provided by the one or more CSPs; updating a data store of the customer with any new or modified resources based on the analyzing; and providing a customer-specific dashboard including analytics for all CSPs associated with the customer of the cloud-based system.

The steps can further include wherein the one or more CSPs includes Google Cloud Platform (GCP), and wherein the retrieving includes accessing the customers' GCP Audit Logs. The one or more CSPs can include Amazon Web Services (AWS), wherein the retrieving includes accessing the customers' AWS CloudTrail Events. The one or more CSPs can include Microsoft Azure, wherein the retrieving includes accessing the customers' Azure Activity Logs. The steps can include creating a connection to the one or more CSPs via Application Programing Interfaces (APIs) associated therewith, wherein the retrieving is performed via the APIs. The analyzing can include applying filtering logic to identify changes for specific resources in the network environments. The steps can include generating real-time notifications based on the analyzing. The steps can include performing a full metadata scan of a resource based on the analyzing. The full metadata scan can be performed in response to one or more specific events identified in the change feeds. The full metadata scan can be performed in response to a number of resources being altered surpassing a threshold.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram outlining an embodiment of a CSP event capture and processing system.

FIG. 6 is a flowchart of a process for a CSP event capture and processing system.

### DETAILED DESCRIPTION OF THE DISCLOSURE

Again, the present disclosure relates to systems and methods for a CSP event capture and processing system. The system is a sophisticated and efficient solution designed to continuously monitor and manage changes within cloud/network environments. By leveraging advanced integration with CSPs such as AWS, Azure, and Google Cloud Platform (GCP), it captures every possible event through APIs like AWS CloudTrail, Azure Activity Logs, and GCP Audit Logs. This system ingests captured events into a structured data pipeline facilitated by Kafka Topics, ensuring efficient handling of large volumes of data. The data processor subsystem then filters and processes these events, identifying significant changes or deltas that require further attention. Relevant changes are subsequently stored in the inventory store and published to Pre-Scan Kafka Topics for additional analysis. Real-time notifications and alerts are generated to promptly address potential issues, while comprehensive logging provides a detailed audit trail for compliance and troubleshooting. Periodic full scans are performed as needed to ensure no changes are missed, and continuous improvements are made to enhance the system's accuracy and efficiency. This helps to handle corner cases where cloud providers are not generating activities. This approach ensures that changes within cloud environments are detected, processed, and managed effectively, significantly enhancing security, compliance, and operational efficiency for customers of the cloud-based system.

### §1.0 Cybersecurity Monitoring and Protection Examples

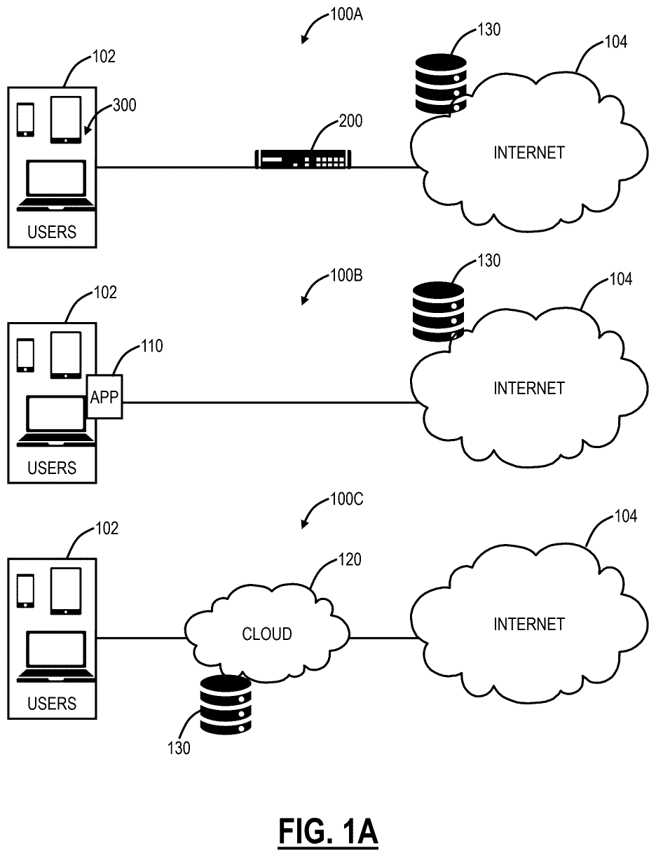

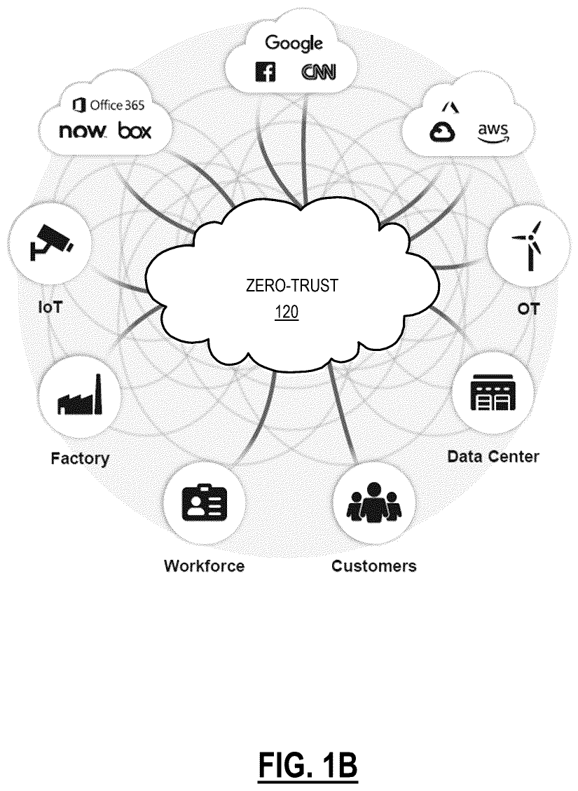

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

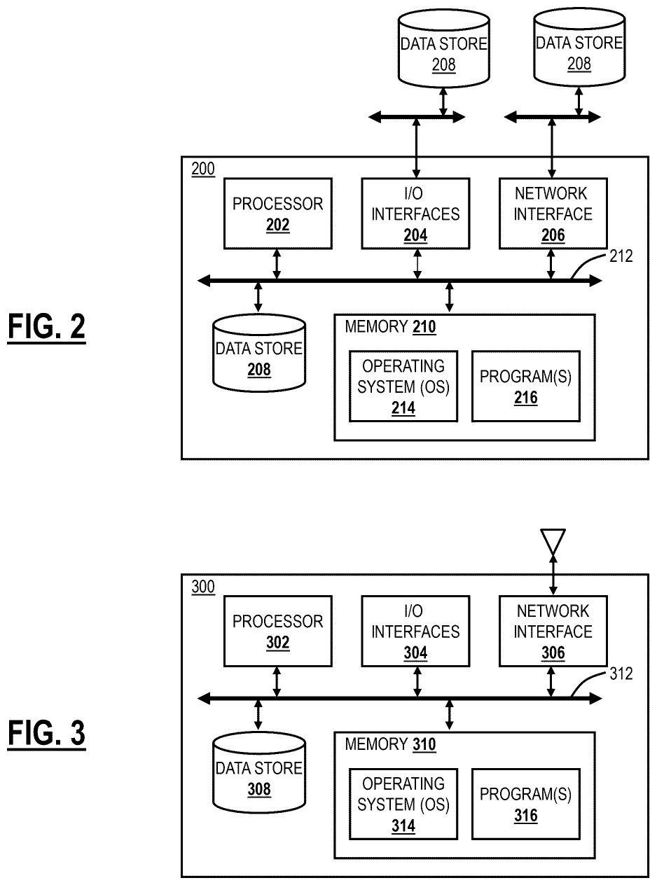

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### §1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### §1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### §1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### §2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### §3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### §4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

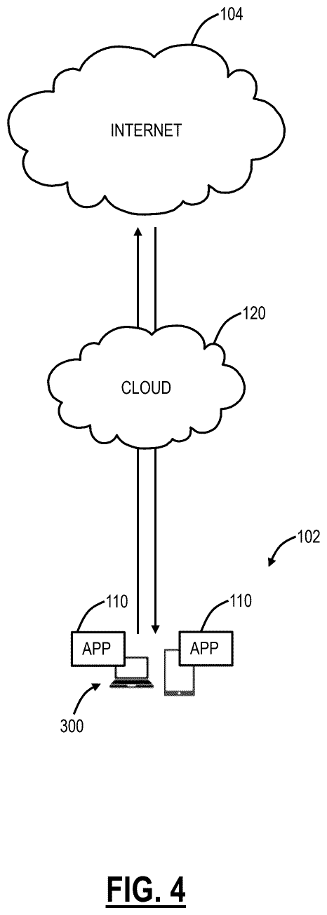

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### §5.0 Posture Control

Posture control is a Cloud-Native Application Protection Platform (CNAPP) offered by the cloud 120 for its tenants designed to provide comprehensive security for cloud-native applications and infrastructure. It offers an agentless solution that identifies and mitigates risks resulting from misconfigurations, vulnerabilities, and potential threats across cloud environments. By integrating multiple security capabilities, the posture control system simplifies the security landscape for organizations operating in the cloud.

One of the key aspects of the posture control system is its comprehensive coverage. It unifies several essential security functions, including Cloud Security Posture Management (CSPM), Cloud Infrastructure Entitlement Management (CIEM), Configuration Management Database (CMDB), and Cloud Workload Protection Platform (CWPP). This consolidation ensures that organizations can manage security across their entire cloud environment from a single platform, making the approach efficient and reducing complexity. Additionally, the platform employs advanced threat and risk correlation techniques, leveraging machine learning to identify and prioritize risks effectively. By correlating seemingly low-risk issues that may pose significant threats when combined, the platform ensures that security teams can focus on remediating the most critical problems.

Another standout feature is its agentless deep scanning capability. The posture control system uses API-based, agentless scanning to analyze container images in registries and virtual machines in production environments. This approach identifies vulnerabilities and prioritizes risks without the need for additional software agents, making the process seamless and efficient. The platform also excels in risk and compliance visualization, providing a comprehensive view of security risks across multi-cloud infrastructures, including virtual machines, containers, and serverless workloads. This comprehensive visibility allows for better understanding and management of the organization's security posture.

The posture control system also emphasizes seamless integration with various development and security tools. It integrates with popular development platforms like Visual Studio Code and DevOps tools such as GitHub and Jenkins. Additionally, it connects with security ecosystems, including ServiceNow, Jira, Splunk, Amazon security lake, and Slack, promoting collaboration across security, development, and operations teams. This integration enables security to become a part of the development lifecycle, enhancing efficiency and reducing the likelihood of vulnerabilities making it to production.

The platform operates by following a structured approach. First, it performs continuous asset discovery, identifying all assets in the cloud environment and assessing them for misconfigurations, vulnerabilities, and compliance issues. Next, the posture control system employs advanced threat correlation and machine learning techniques to prioritize risks based on their potential impact, ensuring that security teams can focus their efforts on the most critical threats. It then offers contextual remediation by providing actionable information, automated guardrails, and guided remediation steps, making it easier for teams to address identified risks. Furthermore, the posture control system includes comprehensive compliance management, using prebuilt security policies and compliance libraries to help organizations maintain regulatory compliance and adhere to internal security standards.

To complement its robust security features, the posture control system integrates into existing development and DevOps workflows, embedding security measures directly into the Continuous Integration and Continuous Delivery (CI/CD) pipeline. This integration helps catch and resolve security issues early in the development process, minimizing the risk of vulnerabilities making it into production environments. Overall, by combining multiple security functions into a unified platform, the posture control system simplifies cloud security management, reduces operational complexity, and significantly enhances the security posture of cloud-native applications and infrastructure.

The posture control system is designed to work seamlessly with major Cloud Service Providers (CSPs), including Amazon Web Services (AWS), Microsoft Azure, Google Cloud Platform (GCP), Kubernetes, and Oracle Cloud Infrastructure (OCI). This integration allows organizations to secure their cloud-native applications and infrastructure across diverse environments. To ensure robust protection, the posture control system provides over 400 security policies tailored to each cloud platform, helping to identify and remediate misconfigurations and excessive permissions. Its agentless architecture, which is API-based, connects directly with CSPs, enabling efficient scanning of virtual machines, containers, and serverless workloads without the need for additional software agents. This approach simplifies deployment and reduces operational overhead.

The posture control system offers unified visibility and control by integrating with multiple cloud platforms, giving security teams a centralized view of risks and compliance statuses across all environments. This unified perspective helps organizations manage and mitigate risks effectively, regardless of where their applications and data are located. Again, the platform also integrates seamlessly with development and DevOps tools like GitHub, Jenkins, and Visual Studio Code, embedding security into the CI/CD pipeline. This integration ensures that security measures are part of the development workflow, fostering collaboration between security and development teams. By supporting a broad range of cloud service providers and development tools, the posture control system helps organizations maintain a consistent and robust security posture across their entire cloud infrastructure, simplifying security management and enhancing the protection of cloud-native applications and data.

### §6.0 CSP Event Capture and Processing System

The present systems and methods are further designed to meticulously capture every possible event originating from a CSP. These events are then transformed into a comprehensive pipeline of events, which is used to verify whether any resources have been altered or updated. This streamlined process is incredibly valuable to customers of the cloud 120, as it enhances their ability to identify and evaluate issues in real-time. By continuously monitoring and analyzing these events, the system ensures that any changes or updates to resources are promptly detected. This real-time detection capability is crucial for maintaining the integrity and performance of customer environments, allowing them to address potential problems swiftly and effectively. Consequently, this robust event capture and processing system significantly contributes to the overall reliability and security of customer cloud operations, providing them with peace of mind and confidence in their infrastructure management.

The present systems, also referred to as the “change feed” plays a crucial role in ensuring that updates from the one or more CSPs are efficiently managed. It connects to and utilizes the CSP Application Programing Interfaces (APIs) to retrieve any changes made within the CSP environment. That is, it connects to CSPs using APIs to retrieve activities that got created based on user's changes performed on the cloud resources. Once these changes are identified, the change feed promptly alerts a full metadata scan component. This notification triggers the component to perform a comprehensive scan, gathering the complete metadata of the affected resources. This process is essential for maintaining accurate and up-to-date information about the resources, ensuring that any modifications are swiftly detected and recorded.

Ensuring that every possible event originating from the CSP is captured and transforming each event into a structured pipeline of events is highly beneficial for customers. This process allows the meticulous monitoring and verification of whether any resources have been altered or updated. By doing so, the systems can significantly enhance the ability to identify and evaluate issues in real-time. This real-time insight is invaluable, as it enables customers to promptly address and resolve any emerging problems, thereby maintaining the integrity and performance of their systems. Ultimately, this capability adds substantial value by providing customers with a robust mechanism for continuous monitoring and immediate issue detection.

Traditionally, rescanning the entire customer account was considered as an alternative to this system. However, this approach is highly inefficient, as it requires repeatedly scanning the account and redundantly using the CSP APIs. This repeated usage not only leads to excessive consumption of API resources but also increases the risk of throttling by the CSP. Additionally, rescanning the entire account does not allow for real-time operation, potentially causing delays in detecting vulnerabilities that could impact our customers.

Events captured from the change feed play a pivotal role in optimizing the monitoring and management processes. By leveraging these events, the system can significantly reduce the need for conducting full scans of the environment, which are often resource-intensive and time-consuming. Instead of scanning the entire system repeatedly, the change feed allows the system to focus only on the specific changes that have occurred. This targeted approach not only enhances efficiency but also provides precise insights into “Who changed What and When?” scenarios.

With the detailed information provided by the change feed events, the system can accurately track and document every modification made to the resources in a plurality of environments associated with a plurality of CSPs. This includes identifying the exact changes, determining who made these changes, and pinpointing the exact time they occurred. Such granularity in monitoring is invaluable for maintaining an accurate and up-to-date understanding of the environment. It aids in swift issue resolution, compliance auditing, and ensuring overall system integrity.

Ultimately, the integration of change feed events into cloud 120 processes allows the cloud 120 to deliver a higher level of service to its customers, enabling them to manage their cloud resources more effectively and with greater confidence.

The present change feed system offers a more efficient solution by breaking down its functionality into two distinct sub-components. The first sub-component, the CSP feed/event capture, is responsible for retrieving change feeds from the CSP APIs. That is, the present systems are adapted to retrieve change feeds from one or more CSPs, thereby collecting change feeds associated with a plurality of network/cloud environments of a customer. The second sub-component, the data processor, analyzes these feeds to identify relevant deltas, which can then be further processed. This structured approach ensures that only the necessary changes are scanned and processed, enabling real-time detection and addressing of potential vulnerabilities, thereby providing enhanced protection for customers.

For example, in an embodiment, the first sub-component which is the change feed event capture, once it has retrieved the change feeds across a timeline, i.e. for previous 5 minutes, from a CSP for a particular account, all these events are maintained in an event pool, and all these events are de-duplicated based on the activity. If create+update+delete activity falls in the same time window, this activity is ignored as there isn't any use with further processing. If update(n)+delete or update(n) events occurs in the same time window, the update activity or the delete activity is picked as it is the latest event and the preceding events in the same time can be ignored.

For the 5 minute window, if the events captured are beyond a certain threshold, the component has the capability to adjust the interested timeline period to collect the events from 5 mins to 2.5 mins, so that feed events are processed immediately in case of heavy activity from the CSP. After some time, the component re-checks and updates the value back to 5 mins, if the activity has reduced.

For each subscription, there is an activity log that records all the events executed in a specific cloud environment, for example in Azure, whether these actions were performed through the Azure Console, Command-Line Interface (CLI), or any other automation tools. To access and utilize these logs, customers must grant the appropriate permissions to allow consumption of the activity log API. These APIs are not readily accessible by default, thus during the account onboarding process, the necessary permissions are obtained from the customer. This setup enables the system to query the activity API effectively, allowing the system to identify and track the relevant events within a specified timeframe.

A similar approach is employed for other cloud service providers. In the case of Amazon Web Services (AWS), the system relies on CloudTrail events to monitor and log activities. For Google Cloud Platform (GCP), Audit Logs serve a similar purpose, capturing all pertinent actions performed within the environment. By acquiring the necessary permissions during the onboarding process for each platform, the system can ensure that it can continuously monitor and analyze these logs in real-time, providing the customers with comprehensive visibility into their cloud activities and enhancing their ability to detect and respond to any potential issues promptly.

Data processing is a critical stage where the system identifies the relevant changes, or deltas, in the environment. These deltas can then be further processed into specific resources and their associated events. In this phase, the data processor subsystem retrieves changes from the CSP, for example via Kafka Topics. Upon receiving these changes, the subsystem applies filtering logic to isolate the changes, based on supported resources and events that are monitored. This filtering ensures that only pertinent changes are processed further. After filtering the changes, it applies de-duplicate logic on the changes to identify the unique resource IDs which are modified.

Once the filtering is complete, the data processor subsystem performs several key activities. Firstly, it updates an inventory store with any new or updated resources, ensuring that the cloud 120 records reflect the current state of the environment. Secondly, it raises events to the Pre-Scan Kafka Topics, facilitating subsequent processing stages.

The filtering logic employed by the data processor is crucial as it ensures that only relevant data is processed, thereby optimizing the efficiency and accuracy of the system. This structured approach allows the event capture and processing system to maintain an up-to-date inventory while promptly identifying significant changes, ultimately enhancing the ability to monitor and manage the cloud environment effectively.

The following is an example of an Azure Event Log, specifically detailing an event related to an Azure virtual machine. This event log is sourced from the Azure activity API and is structured in a clear and organized manner. It includes distinct sections that provide comprehensive information about the event. Key sections of the log include the event name, which identifies the specific event that occurred, and the operation name, which describes the nature of the operation performed. Additionally, the log includes the status, indicating whether the operation was successful or if there were any issues, and the actual activity being performed on the resource, offering detailed insights into what actions were taken. This structured format allows for easy interpretation and analysis, enabling quick understanding of the context and impact of the event.

{

“eventName”: {

“value”: “Microsoft.Compute/virtualMachines/write”,

},

“eventTimestamp”: “2024-10-25T14:52:18Z”,

“category”: “Administrative”,

“operationName”: {

“value”: “Microsoft.Compute/virtualMachines/write”,

},

“status”: {

“value”: “Succeeded”,

},

“subStatus”: {

“value”: “Created”,

},

“caller”: “user@domain.com”,

“description”: “Updated VM instance configuration”,

“subscriptionId”: “{subscription-id}”,

“resourceId”: “/subscriptions/{subscription-id}/resourceGroups/{resource-group-name}/providers/Microsoft.Compute/virtualMachines/{vm-name}”,

“resourceType”: {

“value”: “Microsoft.Compute/virtualMachines”,

},

“properties”: {

“statusCode”: “Accepted”,

},

“eventSource”: “Azure Portal”,

“initiatedBy”: “user@domain.com”,

“role”: “Contributor”

}, etc.

Thus, the event log contains information that allows the present systems to determine if a change was made to a resource that is associated with the customer.

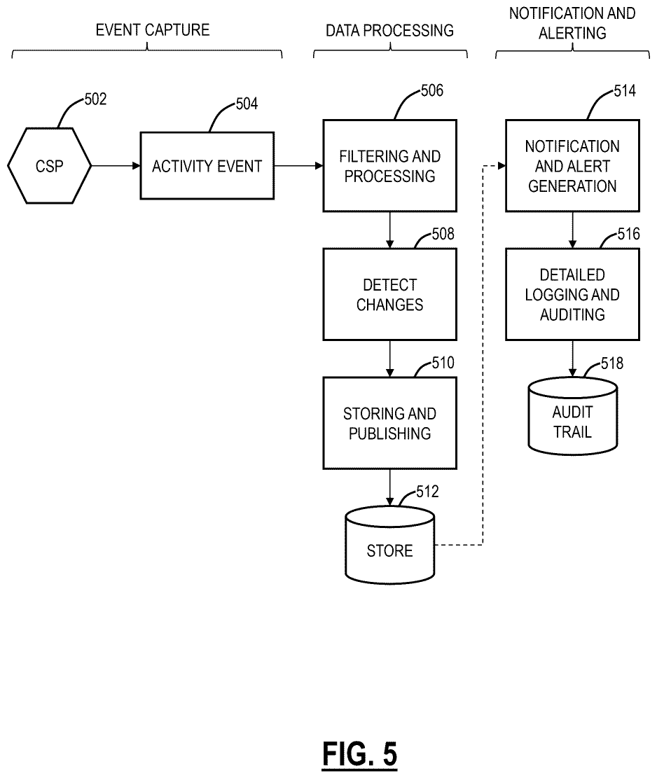

FIG. 5 is a flow diagram outlining an embodiment of the present CSP event capture and processing system, i.e., the “change feed system”. The present change feed system is designed to efficiently monitor and manage changes within cloud environments by capturing and processing events from CSPs 502. The system operates through several key steps to ensure comprehensive and accurate change management. First, the CSP feed phase, i.e., the event capture phase involves continuously monitoring the cloud environment for any changes or events 504. Again, the cloud environment can be one or more environments of a customer of the cloud 120. This is accomplished by interfacing with CSPs'APIs to fetch event data from platforms such as AWS, Azure, and Google Cloud Platform (GCP), utilizing specific APIs like AWS CloudTrail, Azure Activity Logs, and GCP Audit Logs.

Next, during the data processing phase, the captured events 504 are ingested into the system through a structured data pipeline. Events 504 are initially collected via Kafka Topics, which serve as a message broker to manage the large volume of incoming data efficiently. Filtering and processing 506 are performed where the data processor subsystem retrieves events from the Kafka Topics and applies filtering logic to identify relevant changes or deltas 508 for specific resources in the environments such as virtual machines. This filtering is based on the resources supported by the system and the specific events of interest, aiming to isolate significant changes for resources that require further attention.

Once the relevant deltas are identified, storing and publishing 510 begins. The data processor subsystem updates the inventory store 512 with any new or modified resources, ensuring the system's records are always current. Additionally, the system publishes these changes to Pre-Scan Kafka Topics, preparing them for subsequent analysis and processing.

A notification and alerting phase involves generating real-time notifications or alerts 514 for significant changes, allowing administrators to promptly address potential issues. These alerts can be configured to trigger actions such as logging, sending emails, or integrating with other monitoring tools.

Detailed Logging and auditing 516 are also performed where all events and changes are logged in detail, providing a comprehensive audit trail 518. This is essential for compliance, troubleshooting, and forensic analysis, with logs including information on the type of change, the resource affected, the user who made the change, and the exact time the change occurred.

While the primary focus is on incremental changes, the system can also perform periodic full scans if necessary. These full metadata scans can be scheduled during off-peak hours to minimize impact on system performance and to provide a baseline for comparison. Additionally, the full metadata scans can be performed in response to one or more specific events. In an embodiment, a full metadata scan can be triggered in response to a number of resources being altered surpassing a threshold, in response to the security systems of the cloud 120 detecting a cyber-attack, in response to a specific event occurring to a specific resource within the environment, etc. Again, the present systems are performed for all customers of the cloud 120, where, for each customer, the system performs the steps for each of the customers' environments. By performing the present processes in the cloud 120, customers can be presented with a consolidated dashboard that highlights change feeds associated with all of the customers environments across different CSPs. That is, the steps can include presenting a dashboard having the described information and analytics for all CSPs associated with a customer of the cloud 120.

Finally, the system undergoes continuous improvement and tuning to enhance its accuracy and efficiency. This includes updating the filtering logic, optimizing data processing pipelines, and refining alerting mechanisms based on feedback and new requirements. By following these steps, the system ensures that changes within cloud environments are promptly detected, accurately processed, and effectively managed. This robust process significantly enhances the overall security, compliance, and operational efficiency for customers.

### §6.1 CSP Event Capture and Processing Process

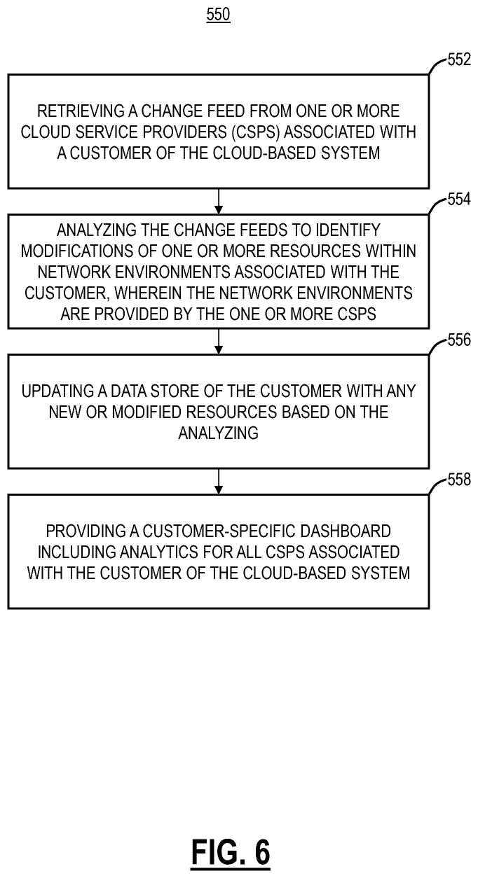

FIG. 6 is a flowchart of a process 550 for a CSP event capture and processing system. In various embodiments, the process 550 can be contemplated as a method having steps, a processing device configured to implement the steps, a cloud-based system configured to implement the steps, and as a non-transitory computer-readable medium storing instructions for programming one or more processors to execute the steps. The process 550 includes retrieving a change feed from one or more Cloud Service Providers (CSPs) associated with a customer of the cloud-based system (step 552); analyzing the change feeds to identify modifications of one or more resources within network environments associated with the customer, wherein the network environments are provided by the one or more CSPs (step 554); updating a data store of the customer with any new or modified resources based on the analyzing (step 556); and providing a customer-specific dashboard including analytics for all CSPs associated with the customer of the cloud-based system (step 558).

The process 550 can further include wherein the one or more CSPs includes Google Cloud Platform (GCP), and wherein the retrieving includes accessing the customers' GCP Audit Logs. The one or more CSPs can include Amazon Web Services (AWS), wherein the retrieving includes accessing the customers' AWS CloudTrail Events. The one or more CSPs can include Microsoft Azure, wherein the retrieving includes accessing the customers' Azure Activity Logs. The steps can include creating a connection to the one or more CSPs via Application Programing Interfaces (APIs) associated therewith, wherein the retrieving is performed via the APIs. The analyzing can include applying filtering logic to identify changes for specific resources in the network environments. The steps can include generating real-time notifications based on the analyzing. The steps can include performing a full metadata scan of a resource based on the analyzing. The full metadata scan can be performed in response to one or more specific events identified in the change feeds. The full metadata scan can be performed in response to a number of resources being altered surpassing a threshold.

### §7.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### §8.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method implemented by a cloud-based system, the method comprising steps of:
retrieving a change feed from one or more Cloud Service Providers (CSPs) associated with a customer of the cloud-based system;
analyzing the change feeds to identify modifications of one or more resources within network environments associated with the customer, wherein the network environments are provided by the one or more CSPs;
updating a data store of the customer with any new or modified resources based on the analyzing; and
providing a customer-specific dashboard including analytics for all CSPs associated with the customer of the cloud-based system.

2. The method of claim 1, wherein the one or more CSPs includes Google Cloud Platform (GCP), and wherein the retrieving includes accessing the customers' GCP Audit Logs.

3. The method of claim 1, wherein the one or more CSPs includes Amazon Web Services (AWS), and wherein the retrieving includes accessing the customers' AWS CloudTrail Events.

4. The method of claim 1, wherein the one or more CSPs includes Microsoft Azure, and wherein the retrieving includes accessing the customers' Azure Activity Logs.

5. The method of claim 1, wherein the steps comprise creating a connection to the one or more CSPs via Application Programing Interfaces (APIs) associated therewith, and wherein the retrieving is performed via the APIs.

6. The method of claim 1, wherein the analyzing includes applying filtering logic to identify changes for specific resources in the network environments.

7. The method of claim 1, wherein the steps comprise generating real-time notifications based on the analyzing.

8. The method of claim 1, wherein the steps comprise performing a full metadata scan of a resource based on the analyzing.

9. The method of claim 8, wherein the full metadata scan is performed in response to one or more specific events identified in the change feeds.

10. The method of claim 8, wherein the full metadata scan is performed in response to a number of resources being altered surpassing a threshold.

11. A non-transitory computer-readable medium comprising instructions that, when executed, cause one or more processors associated with a cloud-based system to perform steps of:
retrieving a change feed from one or more Cloud Service Providers (CSPs) associated with a customer of the cloud-based system;
analyzing the change feeds to identify modifications of one or more resources within network environments associated with the customer, wherein the network environments are provided by the one or more CSPs;
updating a data store of the customer with any new or modified resources based on the analyzing; and
providing a customer-specific dashboard including analytics for all CSPs associated with the customer of the cloud-based system.

12. The non-transitory computer-readable medium of claim 11, wherein the one or more CSPs includes Google Cloud Platform (GCP), and wherein the retrieving includes accessing the customers' GCP Audit Logs.

13. The non-transitory computer-readable medium of claim 11, wherein the one or more CSPs includes Amazon Web Services (AWS), and wherein the retrieving includes accessing the customers' AWS CloudTrail Events.

14. The non-transitory computer-readable medium of claim 11, wherein the one or more CSPs includes Microsoft Azure, and wherein the retrieving includes accessing the customers' Azure Activity Logs.

15. The non-transitory computer-readable medium of claim 11, wherein the steps comprise creating a connection to the one or more CSPs via Application Programing Interfaces (APIs) associated therewith, and wherein the retrieving is performed via the APIs.

16. The non-transitory computer-readable medium of claim 11, wherein the analyzing includes applying filtering logic to identify changes for specific resources in the network environments.

17. The non-transitory computer-readable medium of claim 11, wherein the steps comprise generating real-time notifications based on the analyzing.

18. The non-transitory computer-readable medium of claim 11, wherein the steps comprise performing a full metadata scan of a resource based on the analyzing.

19. The non-transitory computer-readable medium of claim 18, wherein the full metadata scan is performed in response to one or more specific events identified in the change feeds

20. The non-transitory computer-readable medium of claim 18, wherein the full metadata scan is performed in response to a number of resources being altered surpassing a threshold.
